(19) United States
(12) Patent Application Publication
(10) Pub. No.: US 2025/0001509 A1
(43) Pub. Date: Jan. 2, 2025

(54) ROTARY AXIS CALIBRATION WITH SINGLE SCAN

(71) Applicant: James R. Glidewell Dental Ceramics, Inc., Newport Beach, CA (US)

(72) Inventors: Babak Manafighazani, Rancho Santa Margarita, CA (US); Moses Zuniga, Tustin, CA (US); Santosh Gaikwad, Irvine, CA (US); Kunal Patil, Foothill Ranch, CA (US)

(73) Assignee: James R. Glidewell Dental Ceramics, Inc., Newport Beach, CA (US)

(21) Appl. No.: 18/344,521

(22) Filed: Jun. 29, 2023

(51) Int. Cl. B23C 9/00; B23Q 15/20

(52) U.S. Cl. CPC B23C 9/00; B23Q 15/20; B23C 2220/48

(57) ABSTRACT

A computer-implemented system and method of automated milling machine calibration includes receiving a calibration alert from a milling machine; performing automated calibration on the milling machine to determine one or more offsets; and automatically updating milling production instructions with the one or more offsets. A non-transitory computer readable medium storing executable computer program instructions to provide automated milling machine calibration, the computer program instructions including instructions for: receiving a calibration alert from a milling machine; performing automated calibration on the milling machine to determine one or more offsets; and automatically updating milling production instructions with the one or more offsets. A computer-implemented method includes receiving a 3D virtual calibration block scan including a first surface region, a second surface region, and a curved surface region; determining an X-offset based on the first surface region and the second surface region; and determining a Z-offset based on the curved surface region.

### TECHNICAL FIELD

The technical field relates to CNC machine(s).

### BACKGROUND

CNC machines used in milling operations can be subject to misalignment of one or more milling axes. Repeated milling can involve vibrations and resistive forces that can cause misalignment over a period of time. The misalignment can affect the quality of any milled object. Misalignment can be particularly problematic when milling objects requiring fine detail and precision, such as dental prosthesis such as crowns, inlays, etc. Misalignments can cause product defects and increase waste and reduce production.

Manual alignment can be time consuming. Manual alignment can require an operator to track and identify a milling machine in need of calibration, record calibration data, measure manually with a micrometer, check for tolerances, and record values, etc. Accordingly, calibration of rotary axis can be challenging.

### SUMMARY

Disclosed is a computer-implemented method of automated milling machine calibration, including: receiving a calibration alert from a milling machine; performing automated calibration on the milling machine to determine one or more offsets; and automatically updating milling production instructions with the one or more offsets.

Disclosed is a computer-implemented method of calibrating a milling machine, including: receiving a 3D virtual calibration block scan including a first surface region, a second surface region, and a curved surface region; determining an X-offset based on the first surface region and the second surface region; and determining a Z-offset based on the curved surface region.

Disclosed is a non-transitory computer readable medium storing executable computer program instructions to provide automated milling machine calibration, the computer program instructions including instructions for: receiving a calibration alert from a milling machine; performing automated calibration on the milling machine to determine one or more offsets; and automatically updating milling production instructions with the one or more offsets.

Disclosed is a system for automated milling machine calibration, the system including: a processor; and a non-transitory computer-readable storage medium including instructions executable by the processor to perform steps including: receiving a calibration alert from a milling machine; performing automated calibration on the milling machine to determine one or more offsets; and automatically updating milling production instructions with the one or more offsets.

### BRIEF DESCRIPTION OF THE DRAWINGS

FIG. 1 is a diagram illustrating an overview of automated rotary axis calibration with a single scan in some embodiments.

FIG. 2(a) through FIG. 2(d) are various views illustrating a 3D virtual calibration design in some embodiments.

FIG. 3(a) through FIG. 3(c) are various views illustrating a 3D physical block in some embodiments.

FIG. 4(a) through FIG. 4(e) are various views of a milling machine with a mounted physical block in some embodiments.

FIG. 5 is a perspective view illustrating a milling toolpath in some embodiments.

FIG. 6 illustrates a milled physical block in some embodiments.

FIG. 7(a) is a front view illustrating a virtual calibration block scan.

FIG. 7 b) is a diagram showing one or more parts of the virtual calibration block scan.

FIG. 8(a) is a bottom view illustrating determining an X-offset in some embodiments.

FIG. 8(b) is a perspective view illustrating a virtual calibration block scan with a curved region in some embodiments.

FIG. 9 is a diagram illustrating a computing environment in some embodiments.

### DETAILED DESCRIPTION

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Some embodiments can include a computer-implemented method of automated milling machine calibration. The computer-implemented method can include receiving a calibration alert from a milling machine, performing automated calibration on the milling machine to determine one or more offsets, and automatically update milling production instructions with the one or more offsets.

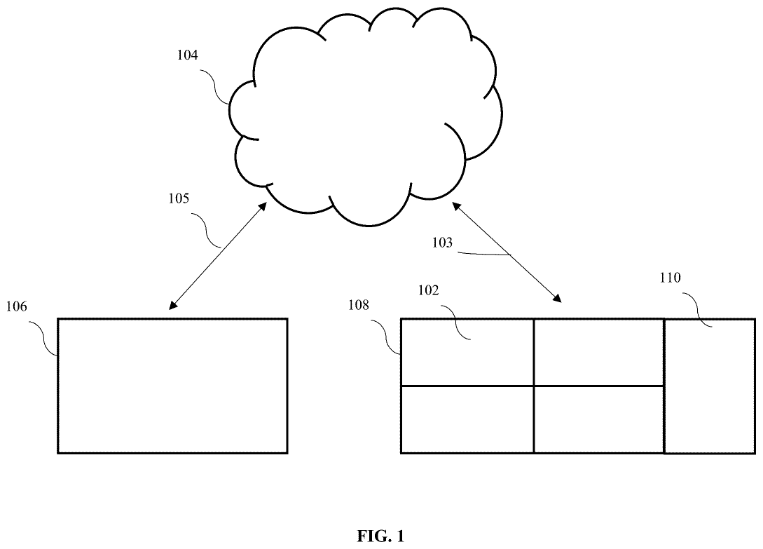

FIG. 1 illustrates an example of automated milling machine calibration in some embodiments. One or more milling machines 108 can be located in a dental laboratory, dental office, or any other facility, and be in communication 103 with one or more computing systems in a cloud computing environment 104 or other networked environment. The cloud computing environment 104 can also be in communication 105 with and one or more scanners 106, such as an optical scanner such as a Polyga C504 scanner available commercially off the shelf. Any other scanner can be used. The cloud computing environment 104 can be of any type, including, but not limited to Amazon AWS, for example. Any other type of cloud computing environment can be used. The one or more milling machines 108 can in some embodiments be dental milling machines used to mill dental prosthesis such as crowns, inlays, etc. Communication can be performed over the internet, through a wireless or cellphone network, or by connected networks. In some embodiments, one or more features can be performed in the cloud computing environment 104. Alternatively, in some embodiments, one or more features can be performed on a computer system that is in communication with the scanner and the one or more milling machines.

In some embodiments, the one or more milling machines can have at least 3 axes, such as a 4 axis Computer Numerical Control (“CNC”) machine. In some embodiments, the milling machine can be any dental mill used to mill dental restorations, including but not limited to those found in dental offices, dental laboratories, or other milling facilities. In some embodiments, the mill can be part of a milling system, such as the milling system described in U.S. Pat. No. 10,838,398, the entirety of which is incorporated by reference herein. In some embodiments, the milling system can include one or more dental milling machines 108 also include a dental block repository 110 of dental blanks used to mill the dental prosthesis. In some embodiments, milling machines can include, for example FastMill™ by Glidewell Laboratories, or other type of milling machine suitable for shaping/milling dental restorations. One example of a milling machine in some embodiments is described in U.S. Pat. No. 10,133,244, which is incorporated by reference herein in its entirety.

During production, the one more dental milling machines 108 can receive requests to mill dental prostheses such crowns, inlays, etc. The one or more dental milling machines can obtain and shape a dental block from the dental block repository 110 for each request during production. Alternatively, the dental blocks can be loaded manually from the dental block repository 110.

In some embodiments, the computer-implemented method can receive a calibration alert from a milling machine. The calibration alert can be triggered by one or more conditions that require the milling machine to be calibrated. For example, in some embodiments, the calibration alert can be triggered when the milling machine reaches or passes a threshold operation value. In some embodiments, the threshold operation value can be based on a user-configurable time period. For example, the calibration alert can be triggered when the milling machine has been operating for a set period of time, which can be configured by the user. In some embodiments, the threshold operation value can be 24 hours. Other user-configurable time periods can be used. In some embodiments, the threshold operation value can be a number of operations, such as a number of dental prosthesis milled and/or operations performed. The calibration alert can be triggered when the milling machine reaches or passes the threshold operation value in some embodiments. In some embodiments, the calibration alert can be triggered manually by an operator or mill user.

Upon reaching the threshold operation value or upon initiation of manual calibration, the milling machine can raise the calibration alert. For example, in some embodiments, milling machine 102 can generate a calibration alert. In some embodiments, the calibration alert can be communicated 103 to the cloud computing architecture or to a connected computer.

In some embodiments, the computer-implemented method can receive the calibration alert from the milling machine and perform calibration on the milling machine. In some embodiments, performing calibration on the milling machine can include milling a 3D virtual calibration design into a physical block with the milling machine that generated the calibration alert.

In some embodiments, the 3D virtual calibration design can include one or more features to calibrate the milling machine. For example, in some embodiments, the 3D virtual calibration design can include a first surface region, a second surface region, and a curved region. In some embodiments, the first surface region and the second surface region can be in the Y-Z plane and each have a depth along an X-axis. In some embodiments, a first surface region depth can differ from a second surface region depth. In some embodiments, the first surface region depth can be less than the second surface region depth. In some embodiments, the first surface region depth can be greater than the second surface region depth. In some embodiments, the first surface region can be arranged between the curved region and the second surface region. In some embodiments, the curved region can be substantially cylindrical, having a radius defined from a center Y-axis of the 3D virtual calibration design and a height along the Y-axis. In some embodiments, the first surface region and the second surface region can be in parallel planes in the 3D virtual calibration design. In some embodiments, the first surface region and the second surface region are substantially flat surfaces in the 3D virtual calibration design.

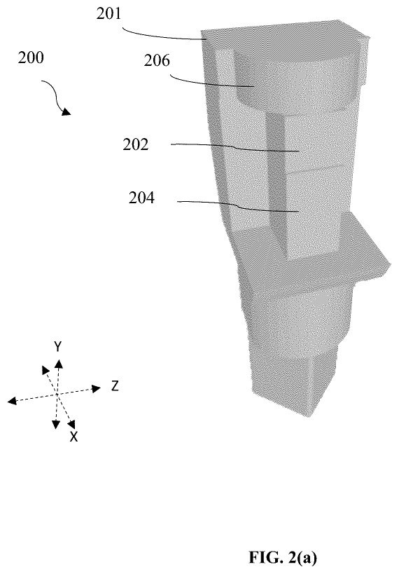

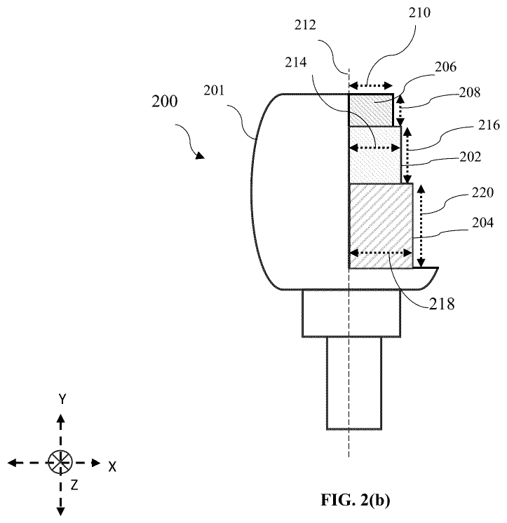

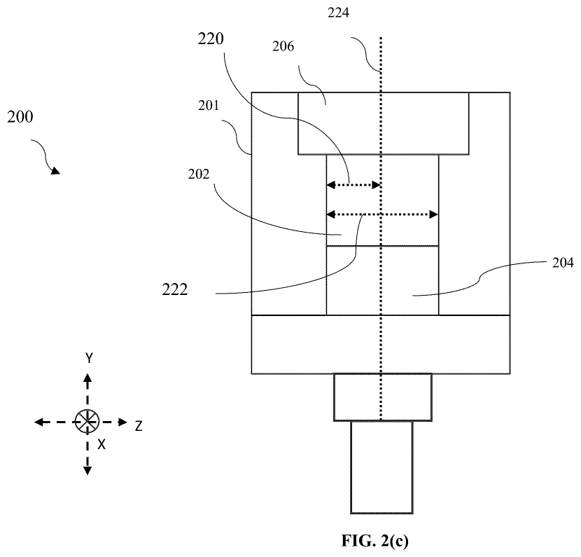

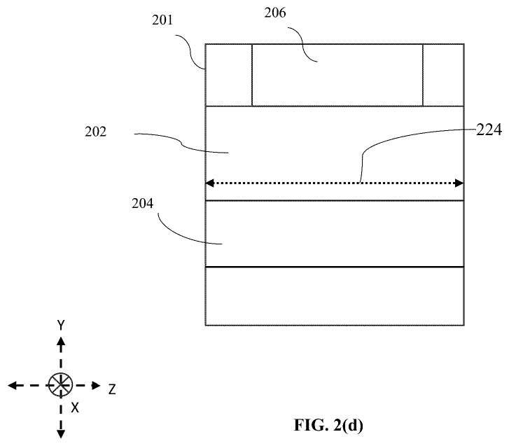

FIG. 2(a) illustrates one example of a 3D virtual calibration design 200 in a virtual block 201 in some embodiments. The 3D virtual calibration design can include the first surface region 202, the second surface region 204, and the curved region 206. As shown in the figure, the first surface region 202 and the second surface region 204 have different depths along the X-axis. In particular, the first region 202 has less depth along the X-axis than the second surface region 204.

FIG. 2(b) illustrates a side view of the 3D virtual calibration design 200 in the virtual block 201. The curved region 206 can include a curved region height 208 along the Y-axis and a curved region radius 210 from the center of the 3D virtual calibration design Y-axis 212. In some embodiments, any suitable value for the curved region height and radius can be used. In some embodiments, the curved region radius 210 can be, for example, in the range from 5.0 mm to 6.0 mm, and the curved region height 208 can be 4.5 mm. However, any other values for the curved region radius 210 and curved region height 208 can be used. In some embodiments, the curved region 206 can be half of a cylindrical shape.

In some embodiments, the first surface region 202 can include a first surface region depth 214 along the X-axis and a first surface region height 216 along the Y-axis. In some embodiments, the first surface region depth 214 and the first surface region height 216 can each be any value. In some embodiments, the first surface region depth 214 can be 6.9 mm and the first surface region height 216 can be 5.5 mm, for example. However, any other suitable value for the first surface region depth 214 and the first surface region height 216 can be used. In some embodiments, the second surface region 204 can include a second surface region depth 218 along the X-axis and a second surface region height 220 along the Y-axis. In some embodiments, the second surface region depth 218 and the second surface region height 220 can each be any suitable value. In some embodiments, the second surface region depth 218 can be 7.2 mm and the second surface region height 220 can be 10.5 mm, for example. However, any other value for the second surface region depth 214 and the second surface region height 220 can be used. In some embodiments, a difference between the first surface region depth 214 and the second surface depth 218 can be any suitable value. In some embodiments, a difference between the first surface region depth 214 and the second surface depth 218 can be up to 0.5 mm, for example.

FIG. 2(c) illustrates a front view of the 3D virtual calibration design 200 in the virtual block 201 showing the curved region 206, the first surface region 202 and the second surface region 204. A first surface region and second surface region width 222 can be any suitable distance along the Z-axis in some embodiments. In some embodiments, for example, the first surface region and second surface region width 222 can be 6 mm. However, any other suitable width value can be used. The virtual block 201 can include a virtual block center axis 224 extending along the Y-axis in some embodiments. In some embodiments, a virtual block center axis distance 220 from either side of the first surface region 202 and the second surface region 204 can be ½ of the width of the first surface region 202 and the second surface region 204 along the Z-axis to the virtual block center axis 224, for example.

FIG. 2(d) illustrates a front view of the 3D virtual calibration design in the virtual block 201 showing the curved region 206, the first surface region 202 and the second surface region 204 in an alternative embodiment. A first surface region and second surface region width 224 can extend up to a virtual block width distance along the Z-axis in some embodiments. In some embodiments, for example, the first surface region and second surface region width 224 can be in the range from 23 mm to 24 mm. However, any other suitable width value can be used.

In some embodiments, performing calibration on the milling machine can include loading a calibration routine generated from the 3D virtual calibration design via a CAD/CAM process into the milling machine. In some embodiments, the calibration routine can be loaded from the cloud computing system or a connected computer. In some embodiments, the calibration routine can include milling instructions such as G code or other milling instructions generated from the CAD/CAM process.

In some embodiments, performing calibration on the milling machine can include loading a physical block into the milling machine. In an automated milling system, this can include automatically retrieving a physical block (also known as a blank) from the dental block repository or other location where physical blocks can be stored. Alternatively, the physical block can be loaded manually into the milling machine.

The physical block can be made of any material suitable for fabricating dental prosthesis such as crowns, inlays, etc. In some embodiments, the physical block can be made of cubic zirconia. Preform body materials comprising hardness values within a desirable range may include metals, such as cobalt chrome, glass and glass ceramics, such as lithium silicate and lithium disilicate, and ceramics, including sintered ceramics comprising alumina and zirconia. Dental restoration materials, including but not limited to commercially available dental glass, glass ceramic or ceramic, or combinations thereof, may be used for making the machinable preforms described herein. Ceramic materials may comprise zirconia, alumina, yttria, hafnium oxide, tantalum oxide, titanium oxide, niobium oxide and mixtures thereof. Zirconia ceramic materials include materials comprised predominantly of zirconia, including those materials in which zirconia is present in an amount of about 85% to about 100% weight percent of the ceramic material. Zirconia ceramics may comprise zirconia, stabilized zirconia, such as tetragonal, stabilized zirconia, and mixtures thereof. Yttria-stabilized zirconia may comprise about 3 mol % to about 6 mol % yttria-stabilized zirconia, or about 2 mol % to about 7 mol % yttria-stabilized zirconia. Examples of stabilized zirconia suitable for use herein include, but are not limited to, yttria-stabilized zirconia commercially available from (for example, through Tosoh USA, as TZ-3Y grades). Methods form making dental ceramics also suitable for use herein may be found in commonly owned U.S. Pat. No. 8,298,329, which is hereby incorporated herein in its entirety. In some embodiments, the physical block can be made of BruxZir material.

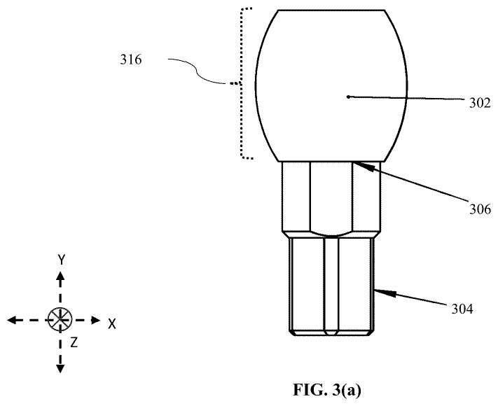

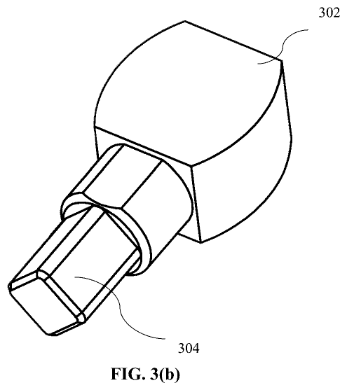

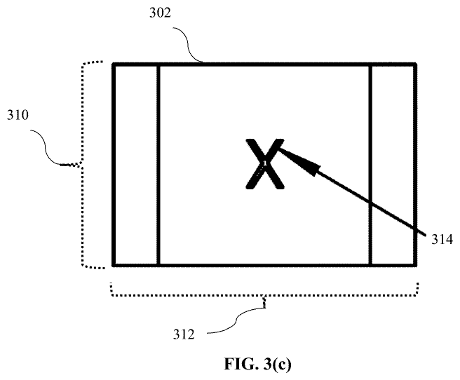

FIG. 3(a), FIG. 3(b), and FIG. 3(c) illustrate different views of an example of a physical block 302 attached to a mandrel 304 with an adhesive such as glue 306. The mandrel 304 can be attached to an arm in the milling machine that can move the physical block 302 and attached mandrel 304 in the X-Y plane of the mill during milling. In some embodiments, the physical block 302 can include a physical block depth 310 that can be of any suitable value for making a restoration. In some embodiments, the physical block depth 310 can be, for example, in the range from 15 mm to 16 mm. In some embodiments, the physical block 302 can include a physical block width 312 that can be of any suitable value. In some embodiments, the physical block width 312 can be in the range from 23 mm to 24 mm. Some embodiments can include optional shade engraving 314. In some embodiments, the physical block 302 can include a physical block height 316 that can be of any suitable value. In some embodiments, the physical block height 316 can be in the range from 23 mm to 24 mm.

In some embodiments, the calibration routine can mill the 3D virtual calibration design into the physical block to provide a 3D physical milled calibration block. The physical milled calibration block can include one or more features corresponding to the 3D virtual calibration design, such as the first surface region, the second surface region, and the curved region. In some embodiments, the calibration instructions can include milling a first side of the physical block, rotating the physical block by 180 degrees, and milling the same design on the second side of the physical block.

In some embodiments, the calibration routine can include instructions to mill a first portion of the first surface region and a first portion of the second surface region from a first side of the physical block, rotate the physical block 180 degrees, and mill a second portion of the first surface region and a second portion of the second surface region from a second side of the physical block. In some embodiments, the mill can also perform a leveling operation by milling the first portion and the second portion of the first surface region at 90 degrees in the Z-direction to be an even surface. In some embodiments, the mill can alternatively perform a leveling operation by milling the first portion and the second portion of the second surface region at 90 degrees in the Z-direction to be an even surface. In some embodiments, the calibration routine can include instructions to mill the curved region by locating the milling tool at a fixed distance along the Z-axis from the physical block and rotating the physical block around the Y-axis.

In some embodiments, milling machine can mill the curved region before or after milling the first portion and the second portion. In some embodiments, the milling machine can mill the first portion of the first surface region and the first portion of the second region from the first direction of the physical block up to a mid region/line such as a center line of the physical block. Accordingly, the first portion of the first surface region and the first portion of the second surface region can extend up to the mid region/line such as the center line of the physical block in some embodiments. In some embodiments, the milling machine can then rotate the physical block by 180 degrees around the Y-axis. In some embodiments, the milling machine can mill the second portion of the first surface region and the second portion of the second region from the second direction of the physical block up to a mid region/line such as a center line of the physical block. Accordingly, the second portion of the first surface region and the second portion of the second surface region can extend up to the mid region/line such as the center line of the physical block in some embodiments. In some embodiments, the mill can also perform a leveling operation by milling the first portion and the second portion of the first surface region at 90 degrees in the Z-direction to be an even surface. In some embodiments, the mill can alternatively perform a leveling operation by milling the first portion and the second portion of the second surface region at 90 degrees in the Z-direction to be an even surface.

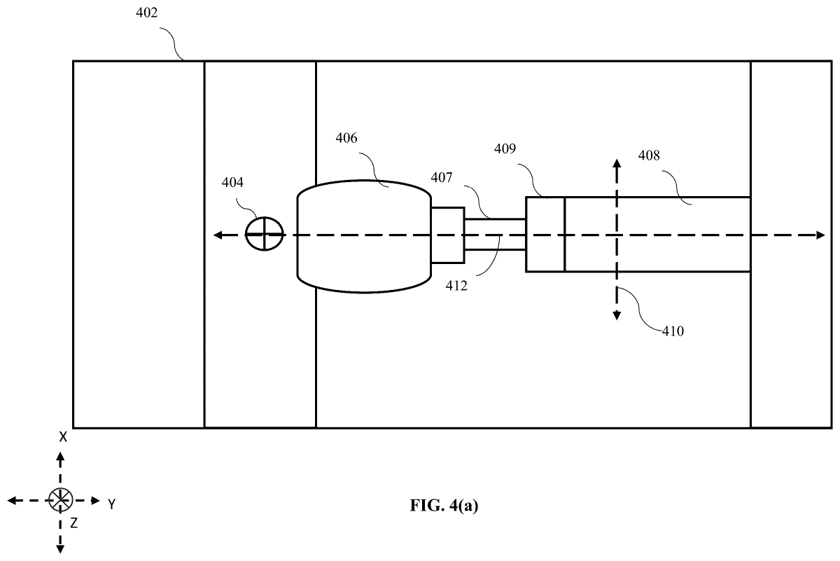

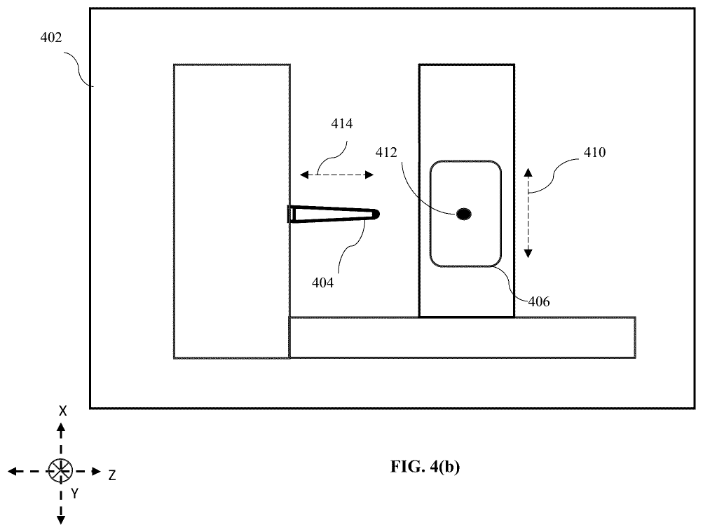

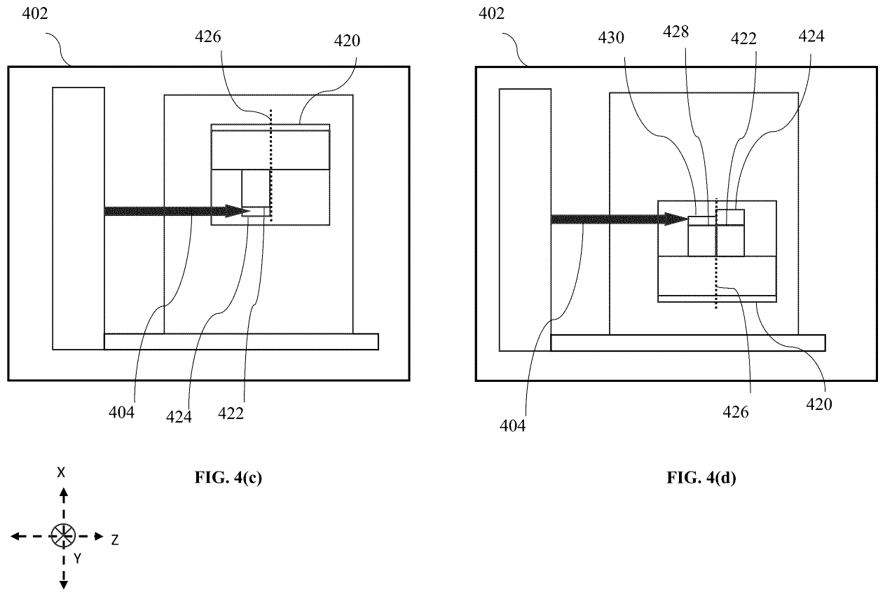

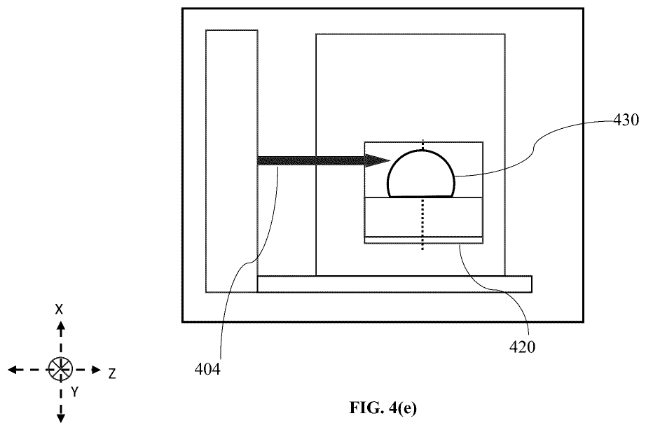

FIG. 4(a) illustrates a front view and FIG. 4(b) illustrates a side view of an example of a milling machine and mounted physical block used to mill the 3D virtual calibration design into the physical block in some embodiments. As shown in FIG. 4(a) a milling machine 402 can include a milling/grinding tool 404 used to mill physical dental blocks. A physical block 406 can be mounted to a mandrel 407 which can be removably attached to a spring loaded attaching region 409 (such as a clamp) of a milling machine arm 408 that can move along an X-direction/axis 410 and Y-direction 412 and rotate around the Y-axis 412. The milling machine arm 408 can move the physical block 406 in the X-Y plane and rotate the physical block 406 around the Y-axis. The milling/grinding tool 404 can move along the Z-axis 414.

FIG. 4(c) illustrates a side view of the milling machine 402 during milling of a physical block 420 in some embodiments. The physical block 420 is shown from a top view, away from the mandrel. As can be seen in the figure, the milling machine 402 mills a first portion of the first surface region 422 and a first portion of second surface region 424 from a first direction with respect to the physical block. In some embodiments, the milling machine mills from the first direction up to a region such as a center line 426 of the physical block 420. Accordingly, the first portion of the first surface region 422 and the first portion of the second surface region 424 can extend up to the center line 426 of the physical block in some embodiments. The calibration routine can instruct the milling machine to then rotate the physical block 420 by 180 degrees.

The milling machine can then mill the second portion from the second side of the physical block 420. FIG. 4(d) illustrates a side view of the milling machine 402 during milling of the physical block 420 in some embodiments. The physical block 420 is shown from a top view. As can be seen in the figure, the milling machine 402 has milled a second portion of the first surface region 428 and a second portion of second surface region 430 from a second direction with respect to the physical block. In some embodiments, the milling machine mills from the second direction up to a region such as a center line 426 of the physical block 420. Accordingly, the second portion of the first surface region 428 and the second portion of the second surface region 430 can extend up to the center line 426 of the physical block in some embodiments. In some embodiments, the mill can also perform a leveling operation by milling the first portion and the second portion of the first surface region at 90 degrees in the Z-direction to be an even surface. In some embodiments, the mill can alternatively perform a leveling operation by milling the first portion and the second portion of the second surface region at 90 degrees in the Z-direction to be an even surface.

As can be seen in FIG. 4(d), the first portion of the first surface region 422 and the second portion of the first surface region 428 are not offset due to leveling of the first portion and the second portion of the first surface region during milling (in the same line along the Z direction). The first portion of the second surface region 424 and the second portion of the second surface region 430 are offset. Due to the offset, the first portion of the second surface region 424 is a different height than the second portion of the second surface region 430 in the X-direction. In some embodiments, this can indicate a calibration offset in the X-direction is required.

In some embodiments, the calibration routine can include milling a curved region into the physical block. In some embodiments, a rough milling of a first portion curved region can be performed when milling the first portions of the first and second surface regions from a first side of the physical block and then repeating the rough milling on a second portion of the curved region after the physical block is rotated 180 degrees. In some embodiments, the first and second surface regions can be milled. Once the first and second surface regions are milled, the calibration routine can instruct the mill to more precisely mill the curved region in some embodiments. In some embodiments, the curved region can be milled by setting the milling tool at a fixed Z-position and rotating the physical block 180 degrees, then moving the block in a Y-direction by a small distance (such as microns, in some embodiments), rotating the physical block back 180 degrees with the milling tool a fixed Z distance to mill another curve into the block, and repeating the process until a desired height in the Y-direction is achieved. In this manner, the calibration routine can mill a curved region at a fixed radius from the center of the physical block and having a height in the Y-direction.

FIG. 4(e) illustrates an example of the calibration routine milling a curved region 430 by rotating the physical block 420 while maintaining the milling tool 404 at a fixed position in the Z-direction.

In some embodiments, the calibration routine milling can be performed as follows:
(1) Roughing with 2 mm tool on a first portion of the first surface region and a first portion the second surface region from a first side of the physical block.
(2) Finishing with 1 mm tool on a first portion of the first surface region and a first portion the second surface region from a first side of the physical block.
(3) Rotating the physical block by 180 degrees
(4) Roughing with 2 mm tool on the second portion of the first surface region and the second portion of the second surface region from a second side of the physical block.
(5) Finishing with 1 mm tool on back surface
(6) Final finishing tool 1 mm and rotating the physical block 180 degrees around the Y-axis back and forth, moving the block in the Y-direction with each rotation to generate a curved region such as a half cylinder. In some embodiments, the milling tool can be moved into the physical block and held at a position of 5.5 mm from the center of the physical block and then rotate the physical block around a Y-axis from 0 degrees to 180 degrees. The physical block can then be moved in the Y-direction and rotate back from 180 degrees to 0 degrees. This process can be repeated until the curved region at the desired curved region height is milled.

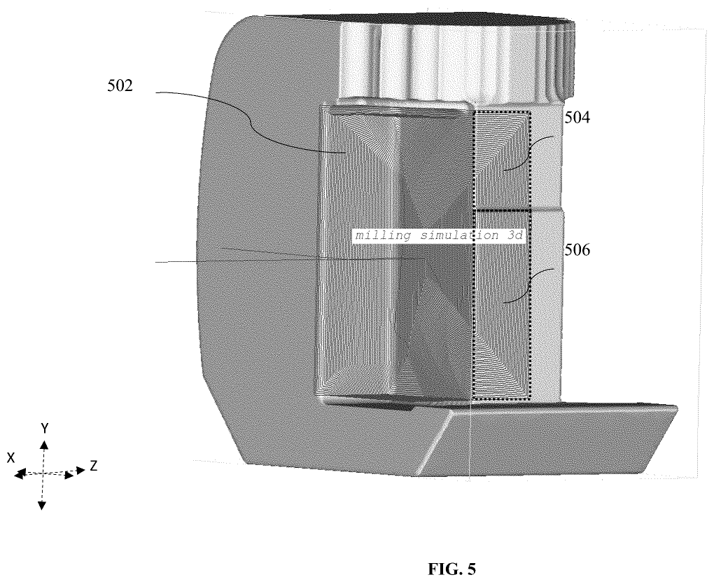

FIG. 5 illustrates a milling path 502 from a first direction to mill the first portion of the first surface region 504 and the first portion of the second surface region 506 in some embodiments.

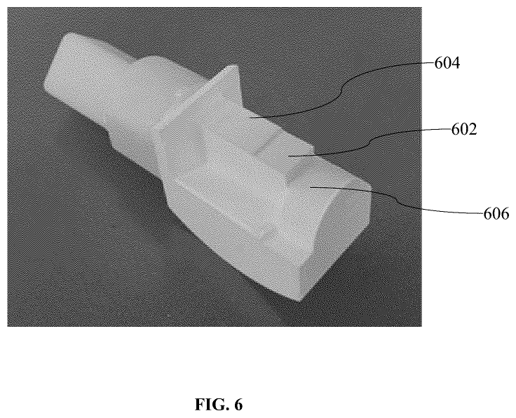

Some embodiments can include milling the block based on the 3D virtual calibration design to provide a 3D physical milled calibration block as part of performing calibration on the milling machine. In some embodiments, milling the block can include following the calibration routine as described herein. FIG. 6 illustrates the 3D physical milled calibration block in some embodiments after milling is complete. The 3D physical milled calibration block can include a first surface region 602, a second surface region 604, and a curved region 606 in some embodiments.

In some embodiments, the 3D physical milled calibration block can be removed from the mill after milling is complete and placed in a 3D scanner for scanning. In some embodiments, the scanner can be a surface scanner. In some embodiments, the front of the 3D physical milled calibration block is scanned to provide a 3D virtual calibration block scan of the 3D physical milled calibration block. In some embodiments, the scanner can scan in 3D, thereby capturing curvature and depth, including curvature of the curved region. The scanner can be any type of scanner known in the art that can generate a 3D virtual calibration block scan of the 3D physical milled calibration block. In some embodiments, the 3D calibration block scan be in the form a point cloud. In some embodiments, the 3D calibration block scan can include a bounding box that indicates the boundary of the scan.

In some embodiments, the computer-implemented method can receive the 3D virtual calibration block scan (also referred to as a “virtual calibration block scan”) as part of performing calibration for the milling machine. In some embodiments, the computer-implemented method can determine a bounding box that includes virtual scanned versions of the first surface region, the second surface region, and the curved region.

In some embodiments, the computer-implemented method can determine one or more calibration offsets for the milling machine based on the 3D virtual calibration block scan. In some embodiments, the one or more calibration offsets can include an X-offset and a Z-offset.

In some embodiments, the computer-implemented method can determine an X-offset amount based on a first portion and a second portion of a second surface region in the 3D virtual calibration block scan. In some embodiments, the computer implemented method can determine an X-offset amount based on an unlevelled surface, which can be either the first surface region or the second surface region. In some embodiments, the computer-implemented method can determine an X-offset direction based on first and second surface regions. In some embodiments, the computer-implemented method can determine the X-offset direction based on a leveled surface and an unleveled surface.

In some embodiments, the virtual calibration block scan can include a first surface region, a second surface region, and a curved region. In some embodiments, the first surface region and second surface region can each include two portions (first and second portions). Accordingly, in some embodiments, the virtual calibration block scan can include four sections: a first section that is a first portion of the first surface region, a second section that is a second portion of the first surface region, a third section that is a first portion of the second surface region, fourth section that is a second portion of the second surface region. Additionally, the virtual calibration block scan can include a curved region.

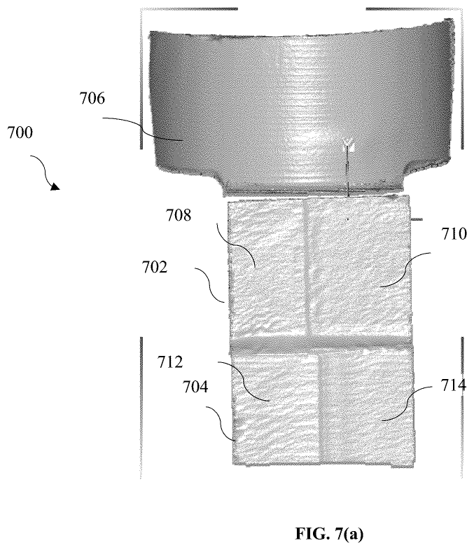

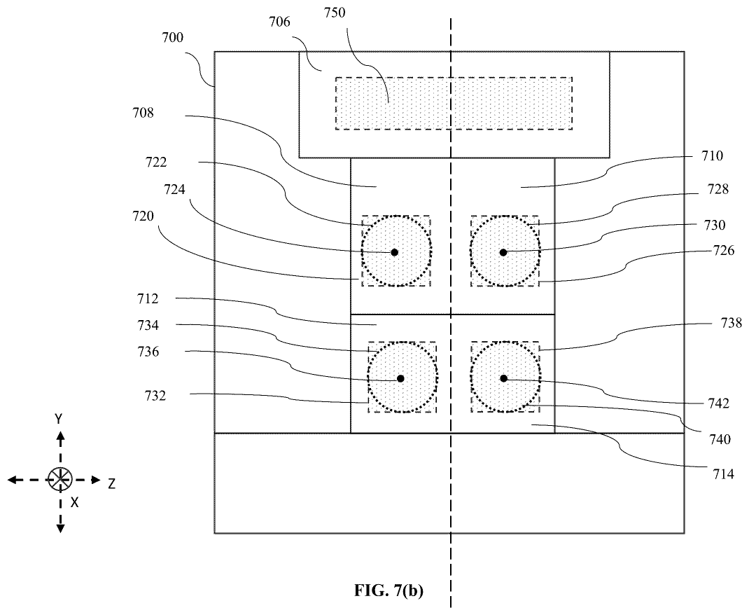

FIG. 7(a) illustrates an example of a virtual calibration block scan 700 in some embodiments. The virtual calibration block scan 700 includes a first surface region 702, a second surface region 704, and a virtual curved region 706. Also shown in the figure are four sections: a first section 708 (the first portion of the first surface region 702), a second section 710 (the second portion of the first surface region 702), a third section 712 (the first portion of the second surface region 704), and a fourth section 714 (the second portion of the second surface region 704).

In some embodiments, the computer-implemented method can determine a first section center point, a second section center point, a third section center point, and a fourth section center point. In some embodiments, the computer-implemented method can set a first section radius around the first center point, a second section radius around the second section center point, a third section radius around the third section center point, and a fourth section radius around the fourth section center point. In some embodiments, the computer-implemented method can set each radius to 1.0 mm. In some embodiments, each radius can be a user-configurable value. In some embodiments, the radius in each of the four sections can be the same value. In some embodiments, the sections can have a different radius values.

In some embodiments, the computer-implemented method can determine a first section plane fitting the first section radius, a second section plane fitting the second section radius, a third section plane fitting the third section radius, and a fourth section plane fitting the fourth radius. In some embodiments, each section plane can be determined by using the least square plane fitting algorithm known in the art.

FIG. 7(b) illustrates a diagram of a virtual calibration block scan in some embodiments. In some embodiments, the computer-implemented method determines the first section plane 720 based on the first section radius 722 around the first section center point 724, the second section plane 726 based on the section radius 728 around the second section center point 730, the third section plane 732 based on the third section radius 734 around the third section center point 736, and the fourth section plane 738 based on the fourth section radius 740 around the fourth section center point 742.

In some embodiments, the computer-implemented method can determine an X-offset amount and an X-offset direction based two or more sections. For example, in some embodiments, the computer-implemented method can determine an X-offset by comparing the third section and the fourth section in embodiments where the first and second sections were levelled. In an alternate embodiment, the computer-implemented method can determine an X-offset by comparing the first section and the second section in embodiments where the third and fourth sections were levelled during milling.

In some embodiments, the computer-implemented method can determine a third section offset amount by projecting the third section center point onto an extension of the fourth section plane and measuring the distance between the projected third section center point and the third section center point. In some embodiments, the computer-implemented method can determine a fourth section offset amount by projecting the fourth section center point onto an extension of the third section plane and measuring the distance between the projected fourth section center point and the fourth section center point. In some embodiments, the projections can be in the normal to the plane onto which the center point is projected. In some embodiments, the computer-implemented method can determine the X-offset amount as an average of the third section offset and the fourth section offset.

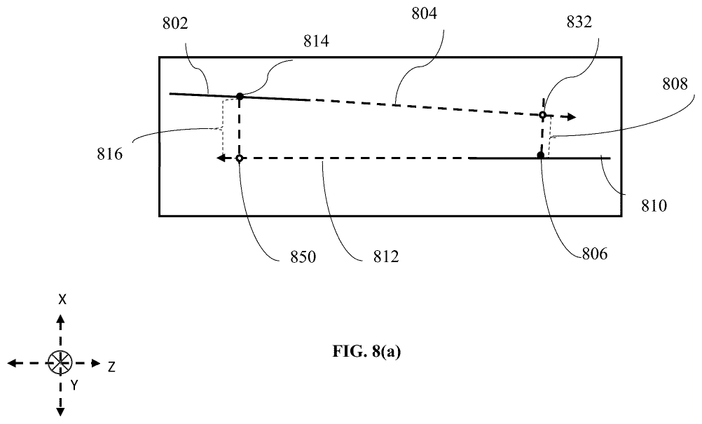

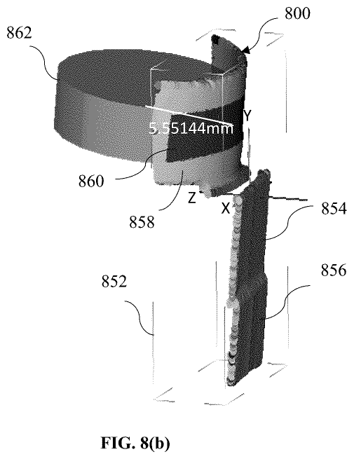

FIG. 8(a) illustrates an example of determining an X-offset amount in some embodiments. A fourth section center point 806 is projected onto an extension 804 of the third section plane 802 to provide a projected fourth section center point 832. The fourth section offset 808 can be measured as a distance between the fourth section center point 806 and the projected fourth section center point 832. A third section center point 814 is projected onto an extension 812 of the fourth section plane 810 to provide a projected fourth section center point 850. The fourth section offset 816 can be measured as a distance between the fourth section center point 814 and the projected fourth section center point 850. The computer-implemented method can then determine the X-offset as the average of the third section offset 816 and the fourth section offset 808.

In some embodiments, the computer-implemented method can determine an X-offset direction. In some embodiments, the computer-implemented method can determine the X-offset direction by comparing a third section distance with a fourth section distance. In some embodiments, the third section distance can be determined as the distance between the third section plane and the first section plane

In some embodiments, the computer-implemented method can determine a third section distance by projecting the third section center point onto an extension of the first section plane and measuring the distance between the projected third section center point and the third section center point to provide a projected third section distance. The computer-implemented method can project the first section center point onto an extension of the third section plane and measure the distance between the projected first section center point and the first section center point to provide a projected first section distance. The computer-implemented method can take the average of the projected third section distance and the projected first section distance to determine the third section distance.

In some embodiments, the computer-implemented method can determine a fourth section distance by projecting the fourth section center point onto an extension of the second section plane and measuring the distance between the projected fourth section center point and the fourth section center point to provide a projected fourth section distance. The computer-implemented method can project the second section center point onto an extension of the fourth section plane and measure the distance between the projected second section center point and the second section center point to provide a projected second section distance. The computer-implemented method can take the average of the projected fourth section distance and the projected second section distance to determine the fourth section distance.

In some embodiments, if the third section distance is greater than the fourth section distance, then the X-offset is in the negative X direction in some embodiments. If the fourth section distance is greater than the third section distance, then the offset is in the positive X direction in some embodiments.

In some embodiments, the computer-implemented method can determine a Z-offset based on the virtual curved region in the 3D virtual calibration block scan. In some embodiments, the computer-implemented method can determine the curved region in the virtual calibration block scan. In some embodiments, the computer-implemented method can determine a smaller curved region of the curved region by offsetting from the boundary of the curved region by a user-configurable amount. In some embodiments, the computer-implemented method can determine a best fit cylinder that matches the curvature of the curved region or the smaller curved region. In some embodiments, the computer-implemented method can determine the radius of the best fit cylinder that matches the curvature. In some embodiments, the computer-implemented method can determine the Z-offset as the difference between the radius of the best fit cylinder and the radius of the curved region in the 3D virtual calibration design.

FIG. 7(b) illustrates an example of a curved region 706 in the virtual calibration block scan 700 in some embodiments. Also shown is a smaller curved region 750. FIG. 8(b) illustrates a virtual calibration block scan 800 that includes a virtual bounding box 852 which is determined using the scan point positions provided by the scanner to indicate the scan bounds. The virtual calibration block scan 800 includes a first surface region 854, a second surface region 856, a curved region 858, and a user-configurable smaller curved region 860. In some embodiments, the computer-implemented method can determine a best fit cylinder 862 and determine its radius. In this example, the best fit cylinder radius is 5.55144 mm. In some embodiments, the computer-implemented method can compare this bet fit cylinder radius with the radius of the curved region in the 3D virtual calibration design to determine a Z-offset.

In some embodiments, the X-offset and Z-offset can be sent to the cloud. In some embodiments, the computer-implemented method can update milling production instructions for the milling machine generating the calibration alert by applying the X-offset and the Z-offset. In some embodiments, the update can be applied to G code. In some embodiments, the X-offset and the Z-offset can be applied only if out of tolerance. In some embodiments, the Z-axis tolerance is within +/−50 microns. In some embodiments, the X-axis tolerance is within +/−20 microns. In some embodiments, the Y-axis tolerance can be +/−2 mm. In some embodiments, the X-offset and the Z-offset can be applied even if the axes are within their respective tolerances.

Some embodiments can include one or more features in various combinations. Some embodiments include a computer-implemented method of automated milling machine calibration, including: receiving a calibration alert from a milling machine; performing automated calibration on the milling machine to determine one or more offsets; and automatically updating milling production instructions with the one or more offsets.

In some embodiments, performing automated calibration can include milling a 3D virtual calibration design into a physical block to provide a 3D physical milled calibration block. In some embodiments, milling the 3D virtual calibration design into the physical block can include milling a first portion of a first surface region and a first portion of a second surface region from a first side of the physical block, rotating the physical block 180 degrees, and milling a second portion of the first surface region and a second portion of the second surface region from a second side of the physical block. In some embodiments, milling the 3D virtual calibration design into the physical block can include milling a curved region into the physical block. In some embodiments, performing automated calibration can include receiving a 3D virtual calibration block scan of the 3D physical milled calibration block. In some embodiments, performing automated calibration can include determining an X-offset amount and direction based on a first surface region and a second surface region in the virtual calibration block scan. In some embodiments, the first surface region, the second surface region, and the curved surface region in the 3D virtual calibration block scan are regions that have been milled. In some embodiments, performing automated calibration can include determining a Z-offset based on a curved region in the virtual calibration block scan.

In some embodiments, a computer-implemented method of calibrating a milling machine, can include: receiving a 3D virtual calibration block scan comprising a first surface region, a second surface region, and a curved surface region; determining an X-offset based on the first surface region and the second surface region; and determining a Z-offset based on the curved surface region. In some embodiments, the first surface region, the second surface region, and the curved surface region in the 3D virtual calibration block scan are regions that have been milled. In some embodiments, determining an X-offset can include determining an X-offset amount based on an unlevelled surface. In some embodiments, determining an X-offset can include determining an X-offset direction based on a leveled surface and an unlevelled surface.

One or more advantages of one or more features in some embodiments can include, for example, detecting and correcting for misalignment of one or more milling axes. One or more advantages of one or more features in some embodiments can include, for example, accounting for misalignment caused by vibrations and resistive forces a CNC machine encounters. One or more advantages of one or more features in some embodiments can include, for example, quality of milled objects after automatic alignment. One or more advantages of one or more features in some embodiments can include, for example, quality of milling objects such as dental prosthesis. One or more advantages of one or more features in some embodiments can include, for example, automated milling calibration measurement. One or more advantages of one or more features in some embodiments can include, for example, precise milling calibration measurement. One or more advantages of one or more features in some embodiments can include, for example, fast calibration.

Some embodiments include a processing system for milling calibration, including: a processor, a computer-readable storage medium including instructions executable by the processor to perform steps including: receiving a calibration alert from a milling machine; performing automated calibration on the milling machine to determine one or more offsets; and automatically updating milling production instructions with the one or more offsets.

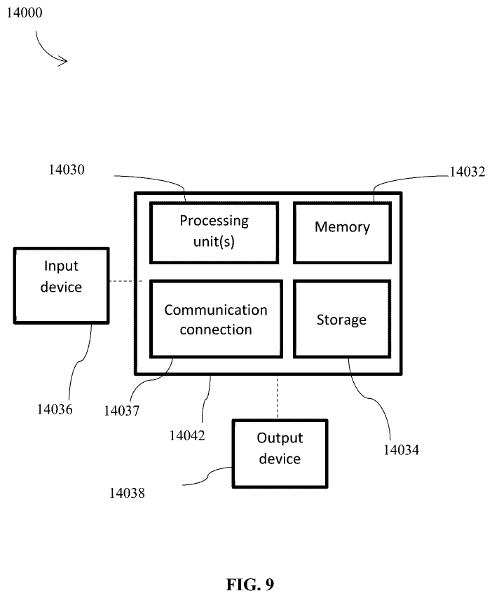

FIG. 9 illustrates a processing system 14000 in some embodiments. The system 14000 can include a processor 14030, computer-readable storage medium 14034 having instructions executable by the processor to perform one or more steps described in the present disclosure.

In some embodiments the computer-implemented method can display a digital model on a display and receive input from an input device such as a mouse or touch screen on the display for example. The computer-implemented method can, upon receiving manipulation commands, rotate, zoom, move, and/or otherwise manipulate the digital model in any way as is known in the art. In some embodiments, the digital models can be CAD models.

One or more of the features disclosed herein can be performed and/or attained automatically, without manual or user intervention. One or more of the features disclosed herein can be performed by a computer-implemented method. The features-including but not limited to any methods and systems-disclosed may be implemented in computing systems. For example, the computing environment 14042 used to perform these functions can be any of a variety of computing devices (e.g., desktop computer, laptop computer, server computer, tablet computer, gaming system, mobile device, programmable automation controller, video card, etc.) that can be incorporated into a computing system comprising one or more computing devices. In some embodiments, the computing system may be a cloud-based computing system.

For example, a computing environment 14042 may include one or more processing units 14030 and memory 14032. The processing units execute computer-executable instructions. A processing unit 14030 can be a central processing unit (CPU), a processor in an application-specific integrated circuit (ASIC), or any other type of processor. In some embodiments, the one or more processing units 14030 can execute multiple computer-executable instructions in parallel, for example. In a multi-processing system, multiple processing units execute computer-executable instructions to increase processing power. For example, a representative computing environment may include a central processing unit as well as a graphics processing unit or co-processing unit. The tangible memory 14032 may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage 14034, one or more input devices 14036, one or more output devices 14038, and one or more communication connections 14037. An interconnection mechanism such as a bus, controller, or network, interconnects the components of the computing environment. Typically, operating system software provides an operating environment for other software executing in the computing environment, and coordinates activities of the components of the computing environment.

The tangible storage 14034 may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage 14034 stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. For video encoding, the input device(s) may be a camera, video card, TV tuner card, or similar device that accepts video input in analog or digital form, or a CD-ROM or CD-RW that reads video samples into the computing environment. The output device(s) may be a display, printer, speaker, CD-writer, or another device that provides output from the computing environment.

The communication connection(s) enable communication over a communication medium to another computing entity. The communication medium conveys information, such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media 14034 (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers) (e.g., the computer-executable instructions cause one or more processors of a computer system to perform the method). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media 14034. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, Python, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosure may be applied, it should be recognized that the illustrated embodiments are only examples and should not be taken as limiting the scope of the disclosure.

What is claimed is:

1. A computer-implemented method of automated milling machine calibration, comprising:
receiving a calibration alert from a milling machine;
performing automated calibration on the milling machine to determine one or more offsets; and
automatically updating milling production instructions with the one or more offsets.

2. The method of claim 1, wherein performing automated calibration comprises milling a 3D virtual calibration design into a physical block to provide a 3D physical milled calibration block.

3. The method of claim 2, wherein milling the 3D virtual calibration design into the physical block comprises milling a first portion of a first surface region and a first portion of a second surface region from a first side of the physical block, rotating the physical block 180 degrees, and milling a second portion of the first surface region and a second portion of the second surface region from a second side of the physical block.

4. The method of claim 3, wherein milling the 3D virtual calibration design into the physical block comprises milling a curved region into the physical block.

5. The method of claim 2, wherein performing automated calibration comprises receiving a 3D virtual calibration block scan of the 3D physical milled calibration block.

6. The method of claim 5, wherein performing automated calibration comprises determining an X-offset amount and direction based on a first surface region and a second surface region in the virtual calibration block scan.

7. The method of claim 5, wherein performing automated calibration comprises determining a Z-offset based on a curved region in the virtual calibration block scan.

8. A computer-implemented method of calibrating a milling machine, comprising:
receiving a 3D virtual calibration block scan comprising a first surface region, a second surface region, and a curved surface region;
determining an X-offset based on the first surface region and the second surface region; and
determining a Z-offset based on the curved surface region.

9. The method of claim 8, wherein determining an X-offset comprises determining an X-offset amount based on an unlevelled surface.

10. The method of claim 8, wherein determining an X-offset comprises determining an X-offset direction based on a leveled surface and an unlevelled surface.

11. A non-transitory computer readable medium storing executable computer program instructions to provide automated milling machine calibration, the computer program instructions comprising instructions for:
receiving a calibration alert from a milling machine;
performing automated calibration on the milling machine to determine one or more offsets; and
automatically updating milling production instructions with the one or more offsets.

12. The medium of claim 11, wherein performing automated calibration comprises milling a first portion of a first surface region and a first portion of a second surface region from a first side of a physical block, rotating the physical block 180 degrees, and milling a second portion of the first surface region and a second portion of the second surface region from a second side of the physical block.

13. The medium of claim 12, further comprising milling a curved region into the physical block.

14. The medium of claim 12, wherein performing automated calibration comprises determining an X-offset amount and direction based on a first surface region and a second surface region in a virtual calibration block scan.

15. The medium of claim 13, wherein performing automated calibration comprises determining a Z-offset based on a curved region in the virtual calibration block scan.

16. A system for automated milling machine calibration, the system comprising:
a processor; and
a non-transitory computer-readable storage medium comprising instructions executable by the processor to perform steps comprising:
receiving a calibration alert from a milling machine;
performing automated calibration on the milling machine to determine one or more offsets; and
automatically updating milling production instructions with the one or more offsets.

17. The system of claim 16, wherein performing automated calibration comprises milling a first portion of a first surface region and a first portion of a second surface region from a first side of a physical block, rotating the physical block 180 degrees, and milling a second portion of the first surface region and a second portion of the second surface region from a second side of the physical block.

18. The system of claim 17, further comprising milling a curved region into the physical block.

19. The system of claim 17, wherein performing automated calibration comprises determining an X-offset amount and X-offset direction based on a first surface region and a second surface region in a virtual calibration block scan.

20. The system of claim 18, wherein performing automated calibration comprises determining a Z-offset based on a curved region in the virtual calibration block scan.
